(19) United States
(12) Patent Application Publication
(10) Pub. No.: US 2026/0191351 A1
(43) Pub. Date: Jul. 9, 2026

(54) COFFEE MACHINE

(71) Applicant: DANPING LIU, Shenzhen City (CN)

(72) Inventor: DANPING LIU, Shenzhen City (CN)

(21) Appl. No.: 19/340,745

(22) Filed: Sep. 25, 2025

(30) Foreign Application Priority Data
Jan. 7, 2025 (CN) 202520038697.5
Jun. 19, 2025 (CN) 202521269540.X

(51) Int. Cl. A47J 31/00; A47J 31/36; A47J 31/44; A47J 31/46; A47J 31/52; A47J 31/56; F16C 19/04; H02J 7/00

(52) U.S. Cl. CPC A47J 31/005; A47J 31/3695; A47J 31/4403; A47J 31/469; A47J 31/52; A47J 31/56; F16C 19/04; H02J 7/855; A47J 2202/00

(57) ABSTRACT

A coffee machine provided in the present invention includes a main body, a rotatable part and an extraction head. A water reservoir, a first control circuit board, and a battery, an electric heating module, and a water pump are all disposed within the main body. The rotatable part has a first side rotatably connected to the main body and can be stored in the main body, and a second side rotatable away from the main body and provided with a circular receptacle for connecting the extraction head. The extraction head can be stored in the water reservoir or detachably mounted in the circular receptacle away from the main body. The water pump connects the water reservoir and the extraction head mounted in the circular receptacle. When making coffee, the coffee cup can be directly placed on the table.

### CROSS REFERENCE TO RELATED APPLICATIONS

The present invention is 35 U.S.C. § 119 benefit of earlier filing dates; rights of priority of Chinese Applications No. 202520038697.5 filed on Jan. 7, 2025, and Chinese Applications No. 202521269540.X filed on Jun. 19, 2025, the disclosures of which are incorporated by reference herein.

### BACKGROUND OF THE INVENTION

### Field of the Invention

The present invention relates to the field of household appliances, and more particularly, to a coffee machine.

### Description of Related Art

With the improvement of living standards, coffee drinks have become a symbol of modern lifestyle, made of roasted and ground coffee beans. People usually have a cup of coffee in the morning or in their spare time. When people enjoy a cup of rich and fragrant coffee in their leisure time, it not only refreshes them but also allows them to fully experience the great relaxation and happiness of their free time. Existing coffee machines generally discharge coffee liquid from the bottom of a water reservoir installed inside a main body. This design requires reserving space for receiving coffee liquid, which reduces the internal space of the main body, and thus a battery with a smaller capacity is installed inside the main body, the smaller battery can heat a reduced cold water. Especially when there is no hot water outdoors, and it is necessary to make multiple servings of espresso, such a design cannot meet the demand; alternatively, if a larger-capacity battery is used, the size of the coffee machine will be increased, making it inconvenient to carry. On the other hand, when making coffee, this kind of coffee machine often requires the user to hold the machine, its holder, or the coffee cup in hand, so it is inconvenient to operate.

### SUMMARY OF THE INVENTION

An object of the present invention is to provide a coffee machine to solve the problems of inconvenient operation and ineffective space utilization of existing coffee machines.

A coffee machine includes a main body, a rotatable part and an extraction head. A water reservoir for accommodating water, a first control circuit board, a battery, an electric heating module for heating water in the water reservoir, and a water pump in fluid communication with the water reservoir, are all installed within the main body. The rotatable part serves as a top shell of the main body and is rotatable relative to the main body between a stored position and an operating position; a hollow shaft is provided at a first side of the rotatable part and is rotatably connected to the main body, and a circular receptacle is provided at a second side of the rotatable part and is arranged side by side with the hollow shaft. The extraction head, is placed in the water reservoir when the coffee machine is in a stored state corresponding the stored position, and is detachably connected to the circular receptacle of the rotatable part when the coffee machine is in an operating state for making coffee corresponding to the operating position of the rotatable part. The first control circuit board is electrically connected to the battery, the electric heating module and the water pump. In the stored state of the coffee machine, the rotatable part rests on a top wall of the main body with the circular receptacle located above the water reservoir; in the operating state, the second side of the rotatable part rotates away from the main body, the circular receptacle departs from the main body, exposing the water reservoir; and the water pump is in fluid communication with the water reservoir and the extraction head connected to the circular receptacle, delivering water from the water reservoir to the extraction head for making coffee.

In some embodiment, the first control circuit board has a power bank discharge function module for charging an electronic device, thereby, the coffee machine is switchable between a coffee-making function and a power bank discharge function for powering the electronic device.

In some embodiment, the coffee machine as claimed in claim 2, wherein a capacity of the battery is above 20000 mAh.

In some embodiment, the first control circuit board is provided with a plurality of electric interfaces, a plurality of indicator lights, and a key module; the indicator lights are used for indicating a battery level or indicating time during a coffee making process. The electric interfaces include a charging interface and a discharging interface, and the first control circuit board controls the battery to charge the electronic device through the discharging interface, thereby implementing the power bank discharge function of the coffee machine. The housing of the main body defines an opening, the first control circuit board is disposed behind the opening, and the plurality of electric interfaces, the plurality of indicator lights and the key module extend from the first control circuit board toward the opening and are exposed on the main body for easy operation or display.

In some embodiment, a second control circuit board is provided within the rotatable part and is connected to the first control circuit board to implement the coffee-making function of the coffee machine; the second control circuit board is provided with an in-position switch for triggering the coffee-making function and/or the power bank discharge function.

In some embodiment, the second control circuit board is provided with a temperature adjustment function module and/or a time adjustment function module; adjustment keys are disposed on a housing of the rotatable part, electrically connected to the second control circuit board, and are used to set temperature and/or time during a coffee making process.

In some embodiment, a guide post is provided below the in-position switch and is connected to a compressible spring; the guide post is movable up and down to push or release the in-position switch.

In some embodiment, the top wall of the main body defines a shaft hole and a water reservoir mounting hole side by side; the hollow shaft rotatably extends within the housing of the main body through the shaft hole; the water reservoir is installed within the housing of the main body with an open top of the water reservoir received in the water reservoir mounting hole.

In some embodiment, the guide post is installed in the rotatable part and is rotatable along with the rotatable part; a protrusion is provided on the top wall of the main body; in the operating state, the guide post rotates onto the protrusion, the protrusion pushes the guide post to move upward to press the in-position switch, thereby triggering the coffee-making function and/or the power bank discharge function; and in the stored state, the guide post rotates away from the protrusion, and the spring drives the guide post to move downward to release the in-position switch.

In some embodiment, a hollow column is set through a bottom wall of the rotatable part; the guide post and the spring sleeved on the guide post are inserted in the hollow column and movable up and down along the hollow column; and the in-position switch is set on a bottom surface of the second control circuit board opposite to the hollow column.

In some embodiment, an annular groove around the hollow shaft is formed on a bottom wall of the rotatable part, an annular flange around the shaft hole on the top wall of the main body is slidable along the annular groove when the rotatable part rotates. An arc-shaped groove on the outer periphery of the hollow shaft is formed on the bottom wall of the rotatable part; the protrusion is in slidable engagement in the arc-shaped groove when the rotatable part rotates. Ball bearings are provided on an outer periphery of the hollow shaft, forming a rolling fit between the bottom wall of the rotatable part and the top wall of the main body; multiple bearing depressions distributed circumferentially around the shaft hole are formed on the top wall of the main body; the ball bearings are in rolling fit with the bearing depressions when the rotatable part rotates. The protrusion is an arc corresponding to an outer periphery of the shaft hole and is located between the annular flange and a circle of the bearing depressions.

In some embodiment, a lower end of the hollow shaft is connected to an end cap for limiting an axial movement of the hollow shaft, allowing the hollow shaft to rotatably fit within the shaft hole without falling out.

In some embodiment, the end cap includes a circular upper plate and a circular lower plate fixedly connected to each other; the circular upper plate is inserted into the hollow shaft and tightly fits; the circular lower plate includes an annular sidewall so as to form an annular groove between the circular lower plate and the circular upper plate; the lower end of the hollow shaft fits into the annular groove; the circular lower plate is clamped outside the shaft hole to limit the shaft. The shaft hole extends downward to form an annular sleeve within the main body; the hollow shaft is inserted in the annular sleeve, and the circular lower plate is clamped outside an open lower end of the annular sleeve. An annular wall extends into the housing of the main body from the water reservoir mounting hole and is adapted to accommodate the water reservoir. A through-hole is formed in the end cap, the circular receptacle defines a through-hole in fluid communication with the extraction head connected to the circular receptacle; a water pipe connects between the water pump and the circular receptacle through the through-hole in the end cap and the hollow shaft, one end of the water pipe is connected to a water outlet pipe of the water pump via a pipe coupling, and the other end of the water pipe is connected to the circular receptacle via another pipe coupling installed in the through-hole in the circular receptacle. The pipe couplings are rotatable 360 degrees.

In some embodiment, the pipe coupling installed in the through-hole in the circular receptacle is connected to a hollow needle, the hollow needle is used for injecting water into the extraction head and piercing a coffee capsule placed in the extraction head.

In some embodiment, the electric heating module includes an electric heating plate serving as a bottom wall of the water reservoir. A temperature sensor is provided for detecting water temperature in the water reservoir and is connected to the first control circuit board for controlling a heating power supplied to the electric heating module. A heating power of the electric heating module, and a capacity and a discharge rate of the battery are configured so that the electric heating module is capable of heating the water in the water reservoir to 86-95° C. within a few minutes.

In some embodiment, a fan is installed within the main body, the housing of the main body defines air inlets and air outlets; a partition plate is provided between the air inlets and the air outlets, correspondingly separating a space within the housing into an air intake side and an air discharge side, and forming a U-shaped airflow path within the housing extending from the air inlets at the air intake side to the air outlets at the air discharge side; the fan is located behind the air inlets; the battery and the first control circuit board are both located within a heat-dissipation coverage of the U-shaped airflow path. When the fan is activated, ambient air is sucked in the main body from the air inlets, flows along the U-shaped airflow path for heat exchange, and then is discharged out of the main body from the air outlets.

In some embodiment, a bracket is provided within the housing of the main body; the battery, the water pump, the first control circuit board, and the water reservoir are installed within the main body via the bracket; the bracket includes a top plate; an annular mounting receptacle is provided on the top plate and is adapted to the water reservoir, the bottom wall of the water reservoir is assembled in the annular mounting receptacle, and the water pump is located below the water reservoir.

In some embodiment, the bottom wall of the water reservoir defines a through-hole for connecting a water inlet pipe of the water pump; the bottom wall of the water reservoir defines another through-hole for installing a temperature sensor for detecting the water temperature in the water reservoir.

In some embodiment, the air inlets and the air outlets are defined in a bottom wall of the main body, the partition plate is set on the bottom wall of the main body and extends upward, and the first control circuit board is supported on a top of the partition plate.

The advantages of the present invention are: the coffee machine of the present application is designed with a rotatable part that can be stored in or rotated away from the main body, and the structure and size of the extraction head and the water reservoir are optimized. In the stored state, the extraction head can be placed in the water reservoir; when in operation, the rotatable part is rotated out of the main body and extends outside, and the extraction head taken out from the water reservoir is installed to the coffee machine and extends outside, optimizing the space utilization and making the overall machine smaller. With the design of the rotatable part, a coffee cup can be directly placed on a table when making coffee, making the machine more convenient to use.

### BRIEF DESCRIPTION OF DRAWINGS

FIGS. 1-2 are exploded views of a coffee machine in a stored state according to an embodiment of the present application;

FIG. 3 is a perspective view of the coffee machine in a stored state according to the embodiment of the present application;

FIG. 4 is a perspective view of a rotatable part of the coffee machine according to the embodiment of the present application;

FIG. 5 is a perspective view of the coffee machine with a rotatable part thereof rotating away from the main body according to the embodiment of the present application;

FIG. 6 a perspective view of the coffee machine in a working state according to the embodiment of the present application;

FIG. 7 is an exploded view of the coffee machine in the working state according to the embodiment of the present application;

FIG. 8 is a left view of the coffee machine in the working state according to the embodiment of the present application;

FIG. 9 is a cross-sectional view taken along line IX-IX in FIG. 8;

FIGS. 10-11 are exploded views of the coffee machine in the working state according to the embodiment of the present application;

FIG. 12 is a bottom view of the coffee machine in the working state according to the embodiment of the present application;

FIG. 13 is a cross-sectional view taken along line XIII-XIII in FIG. 12; and

FIG. 14 is a cross-sectional view taken along line XIV-XIV in FIG. 12.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present invention.

Certain terminology is used in the following description for convenience only and is not limiting. The words “a”, “an” and “one”, as used in the claims and in the corresponding portions of the specification, are defined as including one or more of the referenced items unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

Although the terms first, second, etc. may be used herein to describe various elements, components, regions, layers and/or sections, these elements, components, regions, layers and/or sections shall not be referred to as restricted by these terms. These terms are only used to distinguish one element, component, region, layer or section from another element, component, region, layer or section. Terms such as “first,” “second,” and other numerical terms when used herein do not imply a sequence or order unless clearly indicated by the context.

It will be further appreciated that, for convenience and clarity, spatial terms such as “vertical,” “horizontal,” “up”, “down”, “internal”, “external”, “inside”, “outside”, “below”, “beneath”, “under”, “on”, “top”, “bottom”, “front”, “rear”, “left”, “right” and etc., may be used herein with respect to the drawings. However, the device is used in many orientations and positions, and these terms are not intended to be limiting and/or absolute. For example, if the device in the figures is turned over, elements described as “below” other elements or features would then be oriented “above” the other elements or features. Thus, the example term “below” may include an orientation of above and below. The device may be otherwise oriented (rotated 90 degrees or at other orientations) and the orientation herein should be interpreted accordingly.

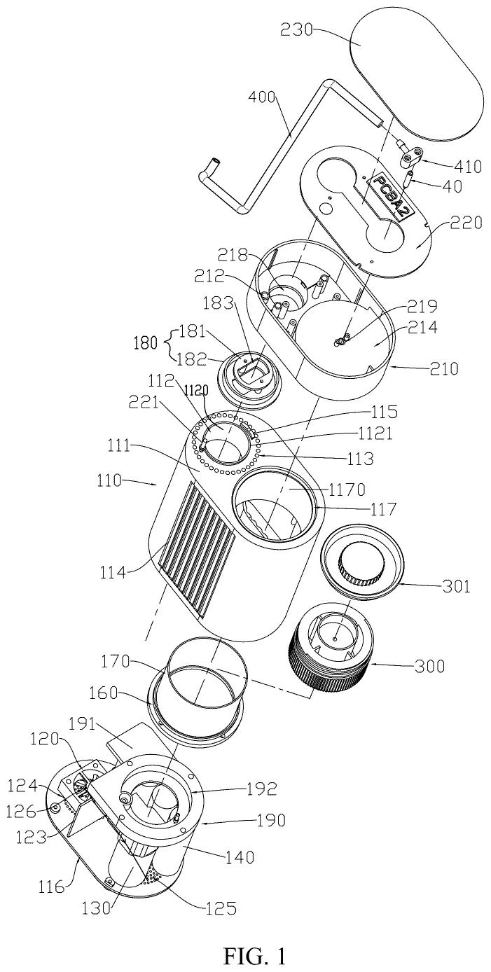

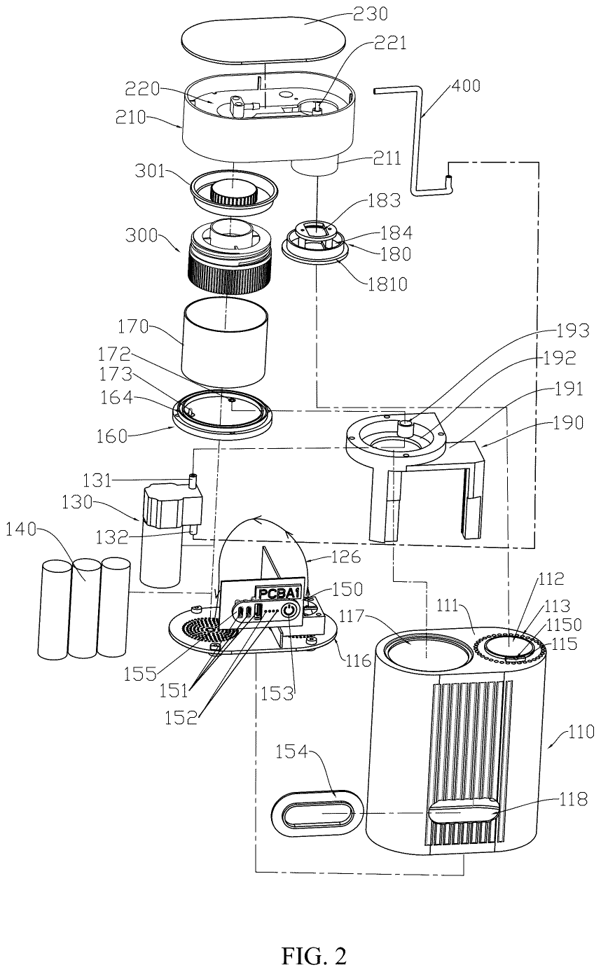

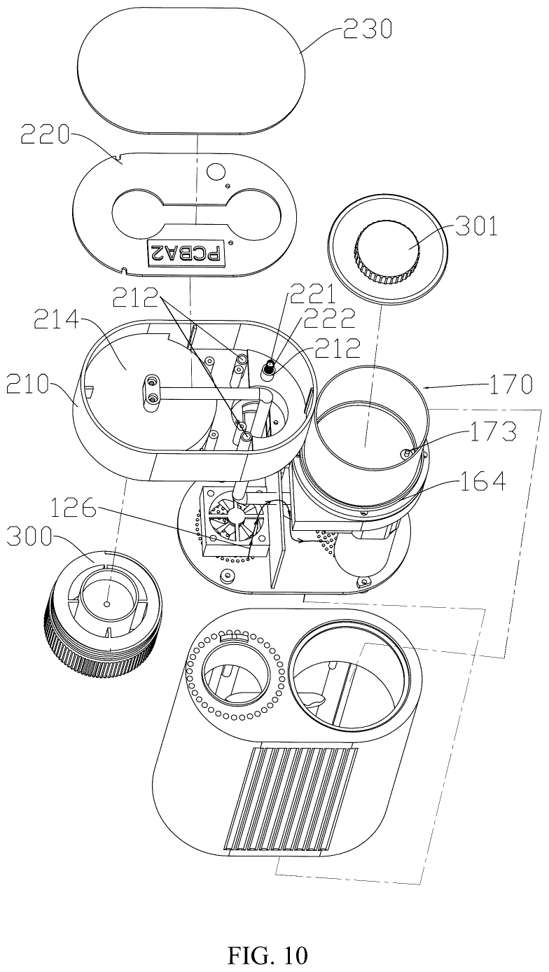

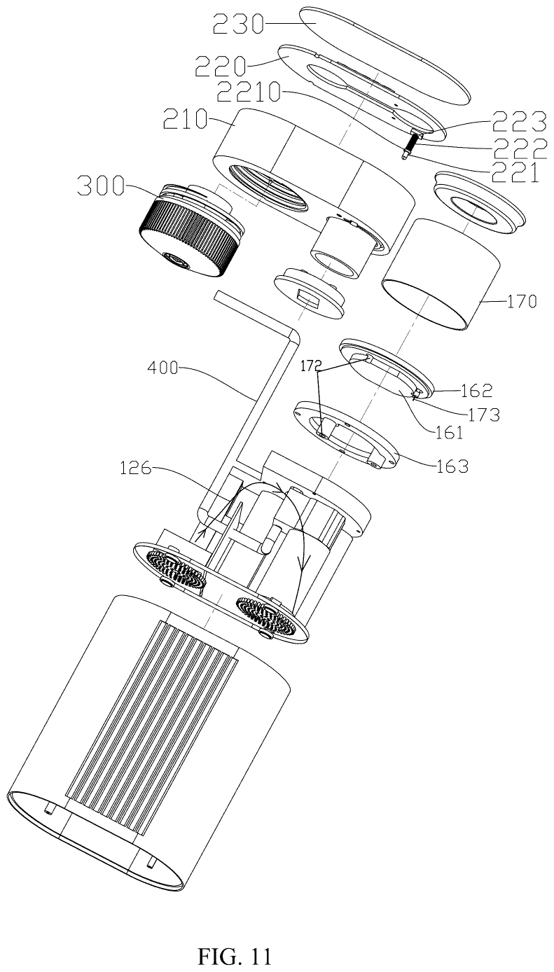

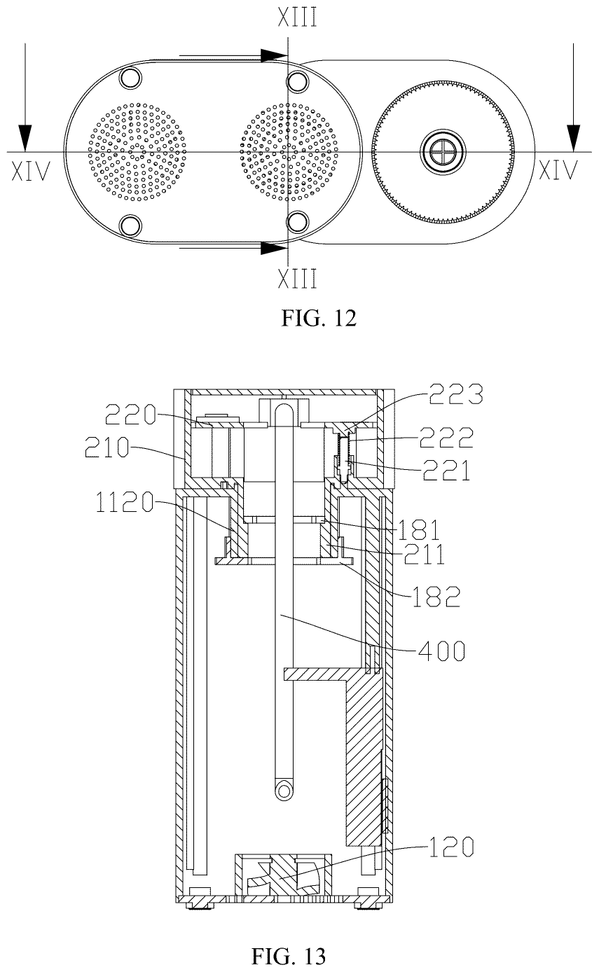

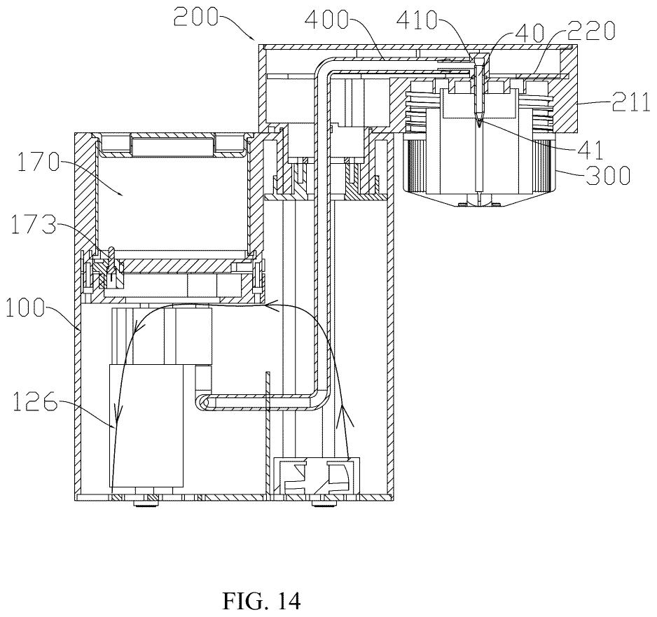

Referring to FIGS. 1-14, the present application relates to a coffee machine, which includes a rotatable part 200, a main body 100 and an extraction head 300. The rotatable part 200 is rotatably connected to the main body 100, and can be rotated to a top of or inside of the main body for storage, or rotated away from the main body 100 to extend outside to install the extraction head 300 for making coffee.

In the specific embodiments described below, the rotatable part 200 is a top shell of the coffee machine. This rotatable design optimizes the space inside the main body 100 of the coffee machine, leaving more room for the battery. The battery capacity can be 20,000 mAh or higher, which is 2.5 to 3 times the battery of existing coffee machines on the market. When the battery capacity is large enough, it can be used for charging mobile phones and other electric devices. The coffee machine of the present application integrates a power-bank discharge function into the control circuit board. The coffee machine of the present application is a portable coffee machine with a power bank discharge function, which meets the user's charging needs. The coffee machine of the present application adopts a large-capacity, high-discharge-rate power battery, which improves the heating power by approximately 2.5 times and shortens the water heating time to approximately two minutes, significantly improving the user experience.

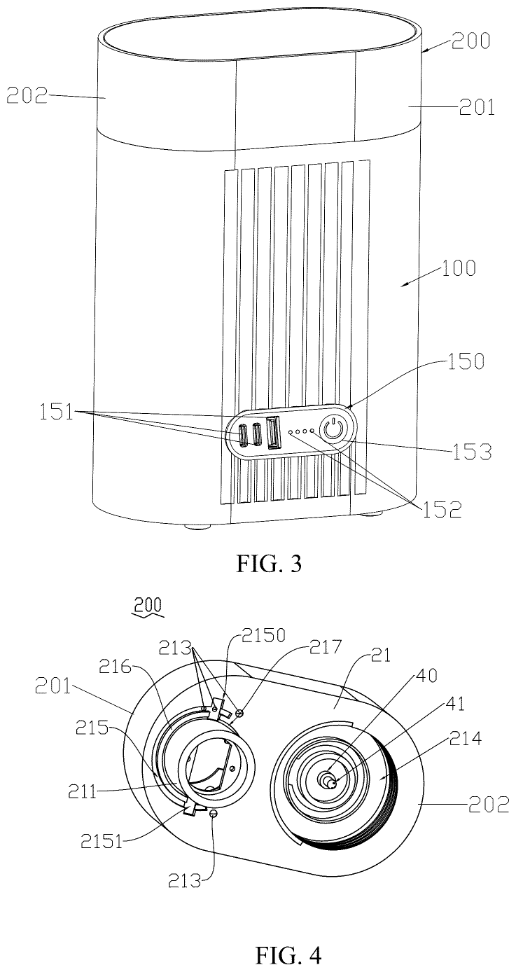

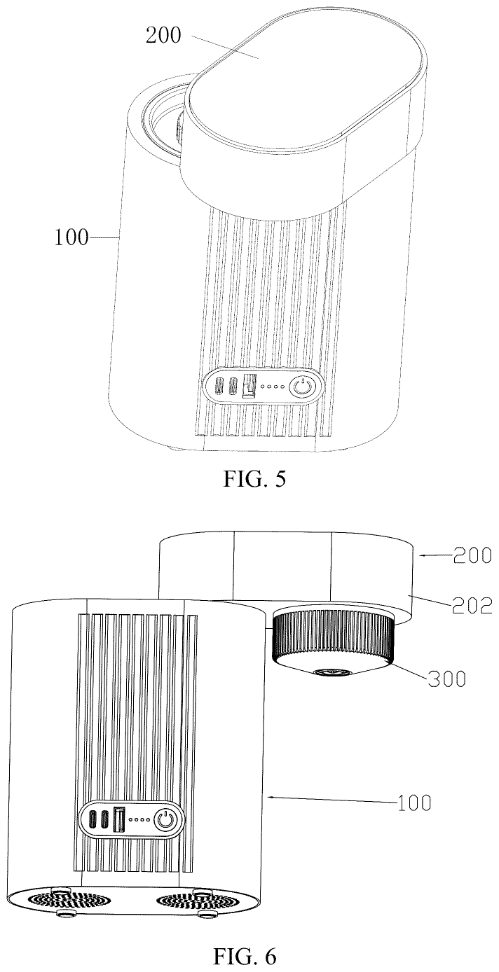

A first side 201 of the rotatable part 200 is rotatably connected to a first side of the top of the main body. The rotatable part 200 can be rotated to cover the top of the main body (refer to FIG. 3), therefore, the coffee machine is in a stored state or in a storage position. In this position, the extraction head 300 can be placed in the water reservoir inside the main body, and the rotatable part 200 is adapted to the shape of the main body 100. For example, the rotatable part 200 and the main body 100 are connected vertically and horizontally to form a cylinder with a consistent appearance. The rotatable part 200 can be rotated until a second side 202 thereof leaves the top of the main body 100 and extends outward. Referring to FIGS. 5-14, the second side 202 of the rotatable part is rotated to extend outward from the main body 100 to provide sufficient space for installing the extraction head 300 for brewing coffee. FIG. 5 shows the process of the rotatable part rotating outward from the storage position, and FIG. 6 shows the rotatable part rotating 180 degrees to the operating position (in the operating state). The spatial direction in which the coffee machine is placed vertically (in the direction of gravity) relative to the ground is taken as an example, that is, the central axis of the coffee machine is vertical (in the direction of gravity), and the rotatable part 200 rotates horizontally relative to the top wall 111 of the main body 100. It should be understood that the vertical or horizontal spatial directions and the spatial orientations of the components described below are relative rather than absolute spatial orientations. It should be understood that the first sides of the rotatable part and the main body may be a central position or a position offset from the center in other embodiments.

The main body 100 includes a housing 110, and a water pump 130, a battery 140, a first control circuit board 150, an electric heating module 160 and a water reservoir 170 arranged inside the housing 110. The water reservoir 170 is used to store water or the extraction head 300. The water pump 130 is in fluid communication with the water reservoir 170 and the extraction head 300 mounted at the bottom of the rotatable part, thereby pumping water in the water reservoir 170 to the extraction head 300 to dissolve and extract the coffee powder placed in the extraction head 300. The electric heating module 160 is used for heating the water in the water reservoir 170. In the following embodiments, the electric heating module 160 includes an electric heating plate 161 and is located at the bottom of the water reservoir 170. In other embodiments, the electric heating module 160 may also be an electric heating wire or other electric heating structures, arranged at an appropriate position such as the bottom, surrounding sides or inside of the water reservoir 170, or installed at any appropriate location inside or outside a water delivery pipeline between the water reservoir 170 and the extraction head 300, or located in the extraction head 300. The water pump 130, the battery 140 and the electric heating module 160 are electrically connected to the first control circuit board 150 and controlled by the first control circuit board 150 to work. The first control circuit board 150 may also be arranged within the rotatable part 200, or a second control circuit board 220 may be provided inside the rotatable part 200 and is connected to the first control circuit board 150.

The housing 110 is cylindrical (not limited to cylindrical), and includes a top wall 111, a cylindrical sidewall 114 and a bottom wall 116. The interior of the housing 110 is hollow. The top wall 111 is planar and defines openings such as a shaft hole 112 and a water reservoir mounting hole 117 arranged side by side. As a non-limiting example, and an annular wall 1170 extends into the housing 110 from the water reservoir mounting hole 117, and is adapted to accommodate the water reservoir 170. An annular sleeve 1120 extends into the housing 110 from the shaft hole 112, and the shaft hole 112 and the annular sleeve 1120 are used to install a shaft 211 of the rotatable part 200. The space inside the housing 110 below the annular wall 1170 and the annular sleeve 1120 is used for installing the water pump 130, the battery 140, the electric heating module 160, and the first control circuit board 150.

The water reservoir 170 and the shaft hole 112 are arranged side by side at the top of the main body 100. The top of the water reservoir 170 is open for filling water, and the water reservoir 170 is adapted to accommodate the extraction head 300. The extraction head 300 can be placed in the water reservoir 170 after being detached from the rotatable part 200, and a lid 301 can also be provided to cover the open top of the water reservoir 170. The rotatable part 200 rotates back to the top of the main body 100 above the top of the water reservoir 170; when rotating out of the main body, it leaves the top of the water reservoir 170, exposing the water reservoir 170, and the extraction head 300 can be taken out of the water reservoir after removing the lid 301. The coffee machine of the present application optimizes the structure and size of the extraction head 300 and the water reservoir 170, and places the extraction head 300 in the water reservoir 170. In this way, the extraction head 300 can also be placed inside the machine in the stored state, making the coffee machine storage and carrying more convenient. In the working state, the extraction head 300 is taken out of the water reservoir 170, coffee powder or a coffee capsule is put in the extraction head 300, and the extraction head 300 is connected to the rotatable part for coffee extraction.

A plurality of bearing depressions 113 arranged in a circle is disposed around the shaft hole 112 on the top wall 111 of the main body (the housing 110). The bearing depressions 113 are preferably hemispherical, evenly distributed on the same circle, and located on the outer periphery of the shaft hole 112. An annular flange 1121 formed on the top wall 111 of the housing 110 surrounding the shaft hole 112 extends upwards, and the annular flange 1121 is slidably engaged in an annular groove 217 (shown in FIG. 4) surrounding the shaft 211 on the bottom wall 21 of the rotatable part 200. The rotatable part 200 is provided with the shaft 211 at its bottom. The rotatable part 200 is connected to the main body 100 with the shaft 211 rotatably inserted in the shaft hole 112 in the top wall of the main body. The shaft 211 is rotatably fitted into the shaft hole 112 and the annular sleeve 1120. Ball bearings 213 (located on the outer periphery of the shaft 211) are disposed between the bottom wall 21 of the rotatable part 200 and the bearing depressions 113 on the outer periphery of the shaft hole 112 on the top wall 111 of the main body. The ball bearings 213 roll in engagement with bearing depressions 113 arranged in a circle, facilitating the rotation of the rotatable part 200 and form rotational limit. It should be understood that the bearing depressions 113 may also be set on the outer periphery of the shaft 211 on the bottom wall of the rotatable part 200. An end cap 180 is located within the housing 110 and can be fixedly connected to the end of the shaft 211 to ensure the shaft 211 being rotatable in the shaft hole 112 without disengaging from the top of the housing 110. A through-hole 183 is formed in the center of the end cap 180, through which the water pipe 400 passes. As a non-limiting example, the end cap 180 includes a circular upper plate 181 and a circular lower plate 182 that are fixedly connected to each other, and the circular upper plate 181 is inserted in the lower end of the hollow shaft 211 and fits tightly. The circular lower plate 182 with a diameter larger than that of the circular upper plate 181, forming an annular groove 184 between the circular lower plate 182 and the upper plate 181. The circular lower plate 182 further includes an annular flange 1810 with a diameter larger than that of the shaft hole 112 (or larger than the end diameter of the annular sleeve 1120), so that the circular lower plate 182 abuts against the outside of the shaft hole 112 (or the open end of the annular sleeve 1120) to limit the position of the shaft 211. The lower end of the hollow shaft 211 abuts within the annular groove 184.

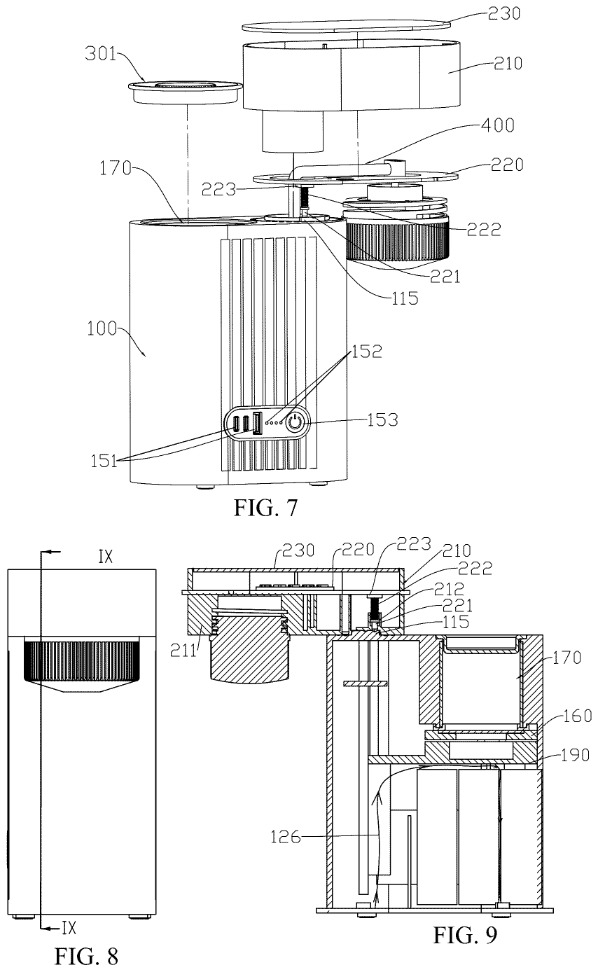

A protrusion 115 is disposed outside the shaft hole 112 on the top wall 111 of the main body (housing 110). The protrusion 115 is preferably an arc shape surrounding the shaft hole 112 and is located between the annular flange 1121 and the circle of the bearing depressions 113. The protrusion 115 can press a guide post 221 to move it upward, triggering an in-position switch 223 (referring to FIGS. 7, 9, 11 and 13) on the second control circuit board 220, thereby achieving function switching, for example, switching between the coffee making function and the power bank discharging function. When the coffee machine is in the stored state, the guide post 221 rotates along with the rotatable part 200 until it is disengaged from the protrusion 115, for example, the guide post 221 moves to a position outside the shaft hole 112 and opposite to the protrusion 115 (as shown in FIG. 1), while the guide post 221 moves downward under an elastic force of a spring 223 on the guide post, no longer pressing the in-position switch 223, the coffee-making function is not activated, and the coffee machine can now be used as a power supply, such as a power bank, to charge external electronic devices. It should be understood that setting the protrusions 115 at different positions enables switching and activation of more functions. These functions are implemented by setting corresponding function modules on the first control circuit board 150 and/or the second control circuit board 220. A recess 1150 may be formed on the protrusion 115 for positioning the lower end of the guide post 221.

A bracket 190 is provided within the main body 100. The water pump 130, the battery 140 and the first control circuit board 150 are mounted via the bracket 190 within the main body 100. The bracket 190 includes a top plate 191 which may be a horizontal plate (relative to the orientation of the main body when placed upright). An annular mounting receptacle 192 is disposed on the top plate 191, and is adapted to fit the water reservoir 170. The bottom of the water reservoir fits in the annular mounting receptacle 192, thereby allowing the water reservoir 170 to be mounted on the top of the bracket 190. A through-hole 193 is provided in the sidewall of the annular mounting receptacle 192, and the through-hole 193 connects to a through-hole 172 in the bottom wall (electric heating plate 161) of the water reservoir 170 and a water inlet pipe 131 of the water pump 130, allowing water in the water reservoir 170 to flow into the water pump 130.

In one embodiment, the electric heating module 160 is a circular heating plate structure that serves as the bottom wall of the water reservoir 170, and is adapted to and fits in the annular mounting receptacle 192 of the top plate 191 of the bracket. The electric heating module 160 includes a circular plate 161, a first annular member 162 and a second annular member 163. The first annular member 162 and the second annular member 163 seal the circular plate 161 with the water reservoir 170 to form the bottom wall of the water reservoir, thereby rapidly heating the water in the water reservoir 170. An annular groove 164 is formed on the first annular member 162 for receiving the annular lower end of the water reservoir 170. An annular groove is formed on the second annular member 163 for mounting the circular plate 161 into the annular mounting receptacle 192 on the top plate 191 of the bracket 190, and fasteners such as screws can be used to further secure the circular plate 161 to the bracket 190. It should be understood that the circular plate 161 and/or the first annular member 162 and/or the second annular member 163 are electric heating elements electrically connected to the first control circuit board 150 and generate heat when energized. Two or three of the circular plate 161, the first annular member 162, and the second annular member 163 may be separate or integrate. The bottom wall (the electric heating module 160 in this embodiment) of the water reservoir 170 defines through holes, where one through hole 172 is in fluid communication with the water pump 130 to allow water flowing from the water reservoir 170 into the water pump 130, another through hole is used to install temperature sensor 173 to measure the temperature of the water or the electric heating module 160. The detected temperature is transmitted to the first control circuit board 150. The first control circuit board 150 controls the current (or heating power) of the electric heating module 160. In some specific embodiments, the electric heating module 160 at the bottom of the water reservoir is a high-power electric heating module to achieve rapid heating of cold water, improves the heating power, and greatly improves the user experience. The electric heating module 160 is electrically connected to the first control circuit board 150, and the temperature sensor 173 is provided for monitoring and controlling the temperature. The temperature sensor 173 is connected to the first control circuit board 150. The coffee machine of the present application uses a large-capacity and high-discharge-rate power battery 140 and a high-power electric heating module 160 to quick heat water, which greatly improves the heating efficiency compared to existing coffee machines. For example, three power batteries 140 are provided in the main body, each power battery 140 has a voltage of 3.7V and a capacity of 7000 mAh. When the three power batteries 140 are connected in series, a total voltage is 11.1V. If the power batteries are discharged at 3 C discharge rate, an output current is 21 A (7000 mAh×3=21000 mAh). The product of current and voltage is power: 11.1×21=233.1 W, which can heat 60 ml of water from a room temperature water to 92° C. in approximately one minute, where 92° C. is the optimal temperature for coffee extraction, but 86-95° C. is also applicable.

The bracket 190 is installed on the bottom wall 116 of the housing 110. The space between the top plate 191 of the bracket and the bottom wall 116 is used for installing the water pump 130, the battery 140 and the first control circuit board 150. The bracket 190 may mount the water pump 130, the battery 140 and the first control circuit board 150 within the housing 110 via a mechanism clamping or fasteners. The water pump 130 is located below the water reservoir 170 and is connected to the water reservoir 170 via a pipeline.

One or more batteries 140 may be set inside the main body 100. The battery can be a primary battery, preferably a rechargeable battery, and more preferably a large-capacity rechargeable battery. For example, the battery capacity may be greater than 20000 mAh, enabling rapid heating cold water to meet the needs of brewing multiple servings of hot coffee. Furthermore, the large-capacity battery allows the coffee machine to function as a power supply device (or power bank) to supply power, which can be used to charge electronic devices such as mobile terminals. In the coffee machine of the present application, the rotatable part 200, serving as the top shell of the main body 100, is rotatable relative to the main body. The internal space of the main body is sufficient to accommodate batteries with a capacity greater than 20000 mAh. In one embodiment, the battery 140 is a large-capacity, high-discharge-rate power battery, significantly improving heating efficiency. As a non-limiting example, three batteries connected in series, each with a voltage of 3.7V and a capacity of 7000 mAh, at a nominal voltage of 11.1V and a discharge rate of 3 C, can heat water from a room temperature to 92° C. in a few minutes. To solve the problem of long heating time of existing coffee machines, the coffee machine of the present application uses large-capacity, high-discharge-rate power batteries to increase the heating power. The heating power is increased by more than 2.5 times, and the water heating time is shortened to about two minutes, greatly improving the user experience.

A fan 120 is disposed within the main body 100 for heat dissipation. The fan 120 is electrically connected to the first control circuit board 150 and controlled by the first control circuit board 150 to work. The housing 110 of the main body is provided with a plurality of air inlets 124 and a plurality of air outlets 125. For example, the air inlets 124 and the air outlets 125 are defined in the bottom wall 116, respectively being a group of through fine holes distributed in a circular area to form a honeycomb pattern. The fan 120 is installed within the housing behind the air inlets 124. When the fan 120 is started, air outside the main body is drawn into the main body through the air inlets 124. The hot air after absorbing heat in the main body flows along an airflow path 126 in the main body 100 and is discharged out of the main body 100 through the air outlets 125. A partition plate 123 is disposed on the bottom wall 116. The partition plate 123 extends upward from the bottom wall 116 (for example, but not limited to, perpendicular to the bottom wall) and is located below the top plate 191 of the bracket, thereby dividing the internal space in the housing 110 (the space between the top plate 191 of the bracket and the bottom wall 116) into two parts: an air intake side (on the side of the air inlets 124) and an air discharge side (on the side of the air outlets 125). The air inlets 124 and the air outlets 125 are respectively located on either side of the partition plate 123, forming a U-shaped airflow path 126 (referring to FIGS. 1-2, 10, 14) within the housing 110 (in the space below the top plate 191 of the bracket). The U-shaped airflow path 126 extends from the air inlets 124 at the air intake side to the air outlets 125 at the air discharge side within the space below the top plate 191 of the bracket. The battery 140, the first control circuit board 150, the water pump 130 and the electric heating module 160 are all mounted within the housing 110, specifically within the space below the top plate 191 of the bracket. These components are all within an air flow coverage of the U-shaped airflow path 126, ensuring effective heat dissipation from components such as the battery 140 and the first control circuit board 150. As a non-limiting example, the battery 140, the water pump 130, the electric heating module 160 and the like are located above the air outlets 125 and on the air discharge side of the partition plate. The fan 120 is disposed above the air inlets 124 and at the air intake side of the partition plate. The first control circuit board 150 is supported by the partition plate 123 and the bracket 190 and can span the left and right spaces (air intake side and air discharge side) divided by the partition plate 123.

The air inlets 124, the air outlets 125, the U-shaped airflow path 126 and the fan 120 constitute a heat dissipation system within the main body 100 of the coffee machine. When the fan 120 is activated, air outside the coffee machine is drawn into the housing 110 through the air inlets 124, flows along the U-shaped airflow path 126, exchanges heat inside the main body 100 to form hot air, and the hot air is discharged out of the coffee machine through the air outlets 125. This heat dissipation system can effectively solve the problem of high temperature in the main body. It should be understood that the air inlets 124 and the air outlets 125 may also be set at other positions of the housing 110, such as in the cylindrical sidewall 114, and the partition plate 123 is arranged correspondingly to separate the internal space within the housing into an air intake side and an air discharge side to form a U-shaped airflow path for heat dissipation.

To solve the problem of excessive internal temperature in the coffee machine due to high-power heating, the fan 120 is provided, and the U-shaped airflow path 126 is formed inside the main body 100 to ensure effective heat dissipation of components such as the battery 140 and the control circuit board 150.

In some specific embodiments, the first control circuit board 150 is provided with a plurality of electric interfaces 151, indicator lights 152 and a key module 153. The housing 110 of the main body 100 defines an opening 118. The first control circuit board 150 is installed behind the opening 118, and the plurality of electric interfaces 151, the plurality of indicator lights 152 and the key module 153 extend from the first control circuit board 150 toward the opening 118 and are exposed on the main body 100 for easy operation or display. The electric interfaces 151, the indicator lights 152 and the key module 153 are secured in the opening 118 via a light guide plate 155 and a snap ring 154. For example, the opening 118 is provided in the front side of the main body, i.e., the front side of the cylindrical sidewall 114. The plurality of electric interfaces 151 include charging and discharging interfaces, or have charging and discharging functions, and may further include a communication interface. The charging interface can be used to charge the battery 140. The discharge interface as a power output port, allows the battery 140 to charge other electronic devices. The communication interface can be used for data or signal transmission. The plurality of indicator lights 152 can be used to indicate the charge level of the battery 140 and the operating status of the coffee machine. For example, the plurality of indicator lights 152 can indicate the remaining battery power by the number of lights on and can also be used to display the coffee brewing time. These functions are controlled and configured on the first control circuit board 15.

In the embodiment of the present application, a large-capacity battery 140 is used, and the first control circuit board 150 includes a charging module. Through the electric interface 151 electrically connected to the first control circuit board 150, the machine (the large-capacity battery 140) can be used to charge electronic devices such as mobile terminals without the need to carry an additional mobile power supply (power bank).

In some embodiments, the first control circuit board 150 mainly implements the power bank function and supplies power to the second control circuit board 220. The second control circuit board 220 mainly implements the coffee extraction function.

The water pump 130 is provided with the water inlet pipe 131 and a water outlet pipe 132. The water inlet pipe 131 is connected to the water reservoir 170, and the water outlet pipe 132 is connected to the water pipe 400. The water pipe 400 extends in the main body 100, passes through the hollow shaft 211 in the shaft hole 122, and extends into the rotatable part 200, reaching the circular receptacle of the rotatable part. A pipe coupling for connecting the end of the water pipe 400 is installed in a through-hole 219 in the circular receptacle 214 at the second side 202 of the rotatable part 200, and is in fluid communication with a water inlet of the extraction head 300 when it is connected to the circular receptacle 214. Either ends (an inlet end and an outlet end) of the water pipe 400 is connected with one 360-degree rotatable pipe coupling. The inlet end of the water pipe 400 is connected to the water outlet pipe 132 of the water pump 130 via one pipe coupling, and the outlet end of the water pipe 400 is installed in the through-hole 219 in the circular receptacle 214 of the rotatable part 200 via another pipe coupling 410 to supply water to the extraction head 300.

In the embodiment shown in the figures, the rotatable part 200, serves as the top shell of the cylindrical main body 100 of the coffee machine, optimizing the internal space of the main body 100 and leaving more room for the battery. The rotatable part 200 includes a housing 210 and a second control circuit board 220 arranged within the housing 210. The housing 210 has a shape corresponding to the housing 110 of the main body, and the second control circuit board 220 is disposed within the housing 210. A top cover 230 covers the open top of the housing 210 to protect the second control circuit board 220.

Referring to FIG. 4, the bottom wall 21 of the housing 210 is adapted to the top wall 111 of the main body 100. The hollow shaft 211 is provided at the bottom wall 21 of the second side 202 of the rotatable part 200 and extends downward. The hollow shaft 211 communicates with the space inside the housing 210, so that the water pipe 400 can pass through the hollow shaft 211 and extend into the interior space within the housing 210 to reach the circular receptacle 214 at the second side 202, thereby delivering water to the extraction head 300. The bottom wall 21 of the rotatable part 200 is provided with an annular groove 217 and an arc-shaped groove 215 on the outer periphery of the hollow shaft 211. The hollow shaft 211 of the rotatable part 200 is inserted in the shaft hole 112 in the top wall 111 of the main body 100 and rotates, the annular flange 1121 around the shaft hole 112 on the top wall 111 of the main body is in slidable engagement along the annular groove 217, and the protrusion 115 on the outer periphery of the shaft hole 112 on the top wall 111 of the main body is in slidable engagement in the arc-shaped groove 215. Ball bearings 213 are disposed between the bottom wall 21 of the rotatable part 200 and the top wall 111 of the main body 100 to form a rolling fit and limiting the rotation. As a non-limiting example, the arc-shaped groove 215 is a semicircle, that is, the rotatable part 200 can rotate 180 degrees. An arc-shaped flange 216 is located between the arc-shaped groove 215 and the annular groove 217. The two ends of the arc-shaped groove 215, as a start end and a stop end, corresponding to the storage position and the operating position of the rotatable part 200 respectively, forms a start recess 2151 and a stop recess 2150 respectively, facilitating the positioning of the protrusion 115 at the storage position and the working position. As a non-limiting example, ball bearings 213 are provided at the stop recess 2150, for example, two ball bearings arranged at intervals, which facilitate interaction with the protrusion 115 to press the guide post 221 upward. Corresponding to the bearing depressions 113 on the top wall 111 of the main body 100, ball bearings 213 are provided on the bottom wall 21 of the rotatable part 200 and roll in engagement in the bearing depressions 113. A plurality of hollow columns 212 may be provided on the bottom wall of the rotatable part 200. The lower ends of the hollow columns 212 pass through the bottom wall so that the opening lower ends can accommodate and limit the ball bearings 213. The top ends of the hollow columns 212 extend upward within the housing 210 and can be used to support the second control circuit board 220. One of the hollow columns is used to accommodate and guide the guide post 221 and the spring 222 sleeved outside the guide post. One end of the spring 222 abuts against a flange 2210 on the guide post, and the other end can abut against the second control circuit board 220.

The bottom wall of the housing 210 defines a through-hole 218 at the first side 201, which is in communication with the hollow shaft 211, the space in the housing 210, and a through-hole defined in the second control circuit board 220, for the water pipe 400 to pass through. A cylindrical circular receptacle 214 is provided at the bottom wall of the housing 210 on the second side 202 for detachably connecting the extraction head 300. For example, an annular sidewall of the circular receptacle 214 is provided with internal threads, and the extraction head 300 is provided with external threads. The extraction head 300 is screwed into or unscrewed from the circular receptacle 214 by rotating it to be mounted in or removed from the circular receptacle 214. Of course, a detachable manner such as clamping or tensioning fit may also be used. A top wall of the circular receptacle 214 defines a through-hole 219 for installing the pipe coupling 410 of the water pipe 400, and the pipe coupling 410 is in fluid communication with the water pipe 400 and the extraction head 300. When coffee powder is placed in the extraction head 300, hot water is supplied via the water pipe 400 through the pipe coupling 410 into the extraction head 300 to make coffee. When a coffee capsule is placed in the extraction head 300, the pipe coupling 410 further connects with a hollow needle 40, and the needle tip of the hollow needle 40 pierces into the capsule. Side injection holes 41 are defined in the needle tip of the hollow needle 40. Water in the water pipe 400 flows into the hollow needle 40 through the pipe coupling 410, and then is injected into the capsule from the side injection hole 41 of the needle tip to dissolve and extract the coffee powder in the capsule. For example, a plurality of side injection holes 41 are defined in the side of the needle tip, making the hot water flow out at higher pressure and stronger impact, so that the hot water fully contacts the coffee powder, effectively dissolving and extracting the coffee powder.

For example, the function of the second control circuit board 220 is mainly to implement the coffee-making function, and it may be provided with a temperature adjustment function module and a time adjustment function module to adjust the water temperature and the time during the coffee-making process. Adjustment keys (not shown) electrically connected to the second control circuit board 220 may be disposed on the top cover 230 to set the water temperature and/or time during the coffee-making process.

The second control circuit board 220 is provided with an in-position switch 223, specifically provided on a lower surface of the second control circuit board 220 (towards the main body 100). The guide post 221 moves upward to press against the in-position switch 223 to start the coffee-making function. The guide post 221 moves downward to release the in-position switch 223 to stop the coffee making function, and at this time, the power bank discharge function can be switched to, and the first control circuit board 150 in the main body 100 controls the large-capacity battery 140 to be used as a power bank to charge electronic devices through the electric interface 151. The hollow column 212 is set on the bottom wall 21 of the housing 210 to accommodate the guide post 221 and rotate along with the rotatable part 200. A spring 222 is sleeved outside the guide post 221, and the two are inserted into the hollow column 212 together. The rotatable part 200 rotates and drives the guide post 221 to rotate along with the shaft 211 in the shaft hole 112. The rotatable part 200 rotates, driving the guide post 221 to rotate together. When rotating to a specified position (for example, the rotatable part 200 rotates 180 degrees), the guide post 221 moves onto the protrusion 115 on the top wall 111 of the main body, the protrusion 115 will lift the guide post 221 to press the in-position switch 223, thereby switching between the coffee-making function and the power bank discharge function and activating the coffee-making function (the electric heating module 160 is energized to heat the water in the water reservoir 170 to a preset water temperature, and the water pump delivers the hot water to the extraction head 300 to dissolve and extract the coffee powder). At the same time, the spring 222 is compressed when the guide post 221 moves upward. When the rotatable part 200 rotates back, the lower end of the guide post 221 leaves the protrusion 115, and the guide post 221 moves downward under the elastic force of the spring 222 to release the in-position switch 223. When the rotatable part 200 rotates to the storage position (rotating back 180 degrees), the protrusion 115 is located at the starting end of the arc-shaped groove 215. When the rotatable part 200 rotates to the working position, the protrusion 115 is located at the stop end of the arc-shaped groove 215. For example, the arc-shaped groove 215 is a semicircle.

The extraction head 300 may adopt a structure in the prior art, with an extraction chamber disposed inside for placing coffee powder or a coffee capsule. The extraction head 300 has a water inlet at the top and a liquid outlet at the bottom. The pipe coupling 410 of the water pipe 400 is connected to the water inlet for injecting water into the extraction chamber. The water injected into the extraction chamber dissolves and extracts the coffee powder, and the prepared coffee liquid is discharged out through the liquid outlet at the bottom. The pipe coupling 410 may also be connected to the above-mentioned hollow needle 40 for piercing the coffee capsule.

During operation, the rotatable part 200 is rotated away from the top of the main body 100 to expose the water reservoir 170, that is, the second side 202 is rotated out of the top of the main body. The extraction head 300 in the water reservoir 170 is taken out and connected to the circular receptacle 214 of the rotatable part. Water is injected into the water reservoir 170, and the rotatable part is rotated to the working position. At this time, the guide post 221 in the rotatable part 200 presses the in-position switch 223 on the second control circuit board 220 in the rotatable part 200 to activate the coffee-making function. The first control circuit board 150 controls the electric heating module 160 to be energized to heat the water in the water reservoir 170 to a preset temperature. The first control circuit board 150 activates the water pump 130 to pump the hot water to the extraction head 300 to dissolve and extract the coffee powder in the extraction head. The coffee liquid can be discharged after soaking the coffee power for a preset duration. After the coffee is made, remove the extraction head and place it in the water reservoir 170. Then, rotate the rotatable part 200 back to above the water reservoir at the top of the main body 100. In the stored state of the machine, the guide post 221 releases the in-position switch 223, and the coffee machine is switched to a state capable of supplying power outward (i.e., the power bank discharge function), which can be used to charge electronic devices.

In the above embodiment, the second control circuit board 220 is disposed within the rotatable part 200, and the first control circuit board 150 is connected to the second control circuit board 220. The circular receptacle 214 for assembling the extraction head 300 and the hollow shaft 211 are disposed on the bottom wall of the rotatable part 200 side by side. The circular receptacle 214 is provided with the pipe coupling 410 (the pipe coupling 410 may also be connected to a hollow needle 40). The water reservoir 170 is connected to the water inlet pipe 131 of the water pump 130 via the water pipe 400. The water outlet pipe 132 of the water pump 130 is in fluid communication with the extraction head mounted in the circular receptacle 214 via the water pipe 400 and the pipe coupling 410. The liquid outlet in communication with the extraction chamber is disposed at the bottom of the extraction head 300; the extraction head 300 is detachably connected to the circular receptacle 214 and can be placed in the water reservoir 170 after being detached. The rotatable part 200 is horizontally rotatable within 180 degrees relative to the main body 100, allowing the extraction head 300 conveniently installed in the circular receptacle 214 of the rotatable part during use. The hollow needle 40 pierces the coffee capsule placed in the extraction chamber 31 of the extraction head 300. Hot water is then pumped from the water reservoir 170 into the hollow needle 40 via the water pump 130 and is injected into the extraction chamber or the coffee capsule of the extraction head through the side injection hole 41 of the hollow needle 40, dissolving and extracting the coffee powder. The hollow needle 40 can pierce various coffee capsules, allowing users to choose coffee flavors. When not in use, the extraction head 300 can be removed and placed in the water reservoir 170 for storage, and then the rotatable part 200 is rotated 180 degrees horizontally relative to the main body 100 to return to the initial position in the stored state.

In the embodiment of the present application, the top wall 111 of the main body 100 defines the water reservoir mounting hole 117 and the shaft hole 112 side by side. The water reservoir 170 is disposed in the water reservoir mounting hole 117. The hollow shaft 211 is disposed at the bottom of the rotatable part 200. An upper circular plate 181 of the end cap 180 is fitted in the hollow shaft 211. The hollow shaft 211 extends into the shaft hole 112 with its lower end connected to the lower circular plate 182 of the end cap and abutting against the periphery of the shaft hole 112. The upper circular plate 181 is fixedly connected to the lower circular plate 182 and fixedly connected to the lower end of the hollow shaft 211, so that the rotatable part 200 can rotate stably relative to the main body 100 without detaching from the main body.

The open top of the water reservoir 170 can be covered with the lid 301; the bottom of the water reservoir 170 is provided with two through holes. One through-holes 172 is in communication with the water inlet pipe 131 of the water pump 130 for the water in the water reservoir 170 to flow into the water pump 130. The temperature sensor 173 is inserted in the other through hole for monitoring the temperature of the water in the water reservoir 170.

The plurality of hemispherical bearing depressions 113 arranged at equal intervals in a circle and the protrusion 115 are disposed on the top wall 111 of the housing 110 around the shaft hole 112. The depress 1150 is formed on the protrusion 115; a semicircular groove (arc-shaped groove) 215 is provided on the bottom wall 21 of the rotatable part 200 and on the outer periphery of the hollow shaft 211. The raised hemisphere (or ball bearing) 213 is embedded in the semicircular groove (arc-shaped groove) 215, effectively preventing misalignment of the rotation of the rotatable part.

In some specific embodiments, the guide post 221 is disposed in the rotatable part 200, and the spring 222 is sleeved outside the guide post 221; the second control circuit board 220 is provided with the in-position switch 223. When the lower end of the guide post 221 moves onto the protrusion 115, the guide post 221 is lifted and its top end presses the in-position switch 223, thereby, the coffee machine is switched to the coffee-making mode. At this time, the power bank discharge mode is disabled; when the guide post 221 is away from the in-position switch 223, the coffee machine is switched to the power bank discharge mode. The in-position switch 223 on the second control circuit board 220 is used to switch between the power bank discharge mode and the coffee-making mode, avoiding voltage instability caused by simultaneous use of the two functions (coffee-making function and power bank discharge function).

When using the coffee machine to make coffee, the rotatable part 200 is first rotated horizontally 180 degrees relative to the main body 100, a coffee capsule (that can serve as an extraction chamber) is placed into the extraction head 300 or coffee powder is placed into the extraction chamber of the extraction head, the extraction head is then mounted in the circular receptacle 214 of the rotatable part via a threaded connection. If a coffee capsule is placed, the hollow needle 40 pierces the coffee capsule. The power button is pressed to activate the electric heating module 160 in the coffee machine to heat the cold water in the water reservoir 170. After the temperature sensor detects that the water in the water reservoir 170 has been heated to the preset water temperature, the hot water in the water reservoir 170 is pressurized by the water pump 130 and is injected into the extraction chamber through the pipe coupling 410 of the water pipe 400 (or via the side injection hole 41 of the hollow needle 40 connected to the pipe coupling 410) for coffee extraction. The extracted coffee liquid flows out from the liquid outlet connected to the extraction chamber, thereby completing the coffee making. When the coffee machine is not in use, the extraction head 300 can be removed and placed in the water reservoir 170, and then the rotatable part 200 is rotated back 180 degrees horizontally relative to the main body 100 to return to its initial storage position. Therefore, during brewing, the user simply touches the power button of the key module 153 to start brewing coffee. The user can also adjust the time/temperature by operating the time/temperature adjustment button the top cover 230 of the rotatable part 200 to adjust the temperature to suit the coffee taste, making brewing coffee quick and easy. When the user's mobile device is out of power, a data cable can be inserted into the power output port (electric interface) 151 on the main body to charge the mobile device, and the coffee machine can then function as a power bank.

In the above embodiment, the coffee machine is designed as a cylinder, and its top shell is rotatable, rotating away from the main body to utilize the external space is used to install the extraction head for coffee making. The internal space of the main body 100 is not occupied, thereby optimizing the internal space of the coffee machine and leaving more space for the battery 140. The battery capacity can be 20000 mAh or higher, which is 2.5 to 3 times that of existing coffee machine on the market. considering that mobile phones and other small electronic devices may need to be charged when used outdoors, the coffee machine with the power bank discharge function can be used to charge these electronic devices. The coffee machine of the present application is portable and meets the changing needs of consumers.

To address the issue of long heating times in existing products, the coffee machine of the present application has a large-capacity, high-discharge-rate power battery, which increases the heating power supplied to the electric heating module 160 by more than 2.5 times, shortening the water heating time to approximately two minutes, significantly improving the user experience.

To solve the problem of excessive internal temperature in the product caused by high-power heating, the coffee machine of the present application is equipped with an additional fan 120. A U-shaped airflow path 126 is designed within the coffee machine, and the heat dissipation area substantially covers the electronic components, ensuring effective heat dissipation for components such as the battery 140 and circuit board 150.

The coffee machine of the present application is switchable between the coffee-making function and the power bank discharge function via the in-position switch 223. When the top rotatable part 200 is rotated to a preset position, the power bank discharge function and the coffee-making function are switchable by touching the in-position switch 223, and the power bank discharging function may be disabled or restricted when switching to the coffee making function.

The present application optimizes the shape and dimensions of the extraction head 300 and the water reservoir 170 to accommodate the extraction head 300 in the water reservoir 170. In this stored state, the extraction head can be placed inside the machine, making it more convenient to use.

In other embodiments, an opening is formed on the sidewall 114 of the main body 100 at a position corresponding to the water reservoir 170, or a closable side cover is provided. The rotatable part 200 is rotated and stored at the position where the water reservoir is located. The water reservoir 170 and the extraction head 300 can rotate away from the main body 100 together with the rotatable part 200 or rotate back to be stored in the main body 100. After rotating away, the water reservoir 170 can be removed and mounted on the top of the bracket 190, and then the coffee-making process can be performed.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. A coffee machine, comprising:
a main body, comprising:
a water reservoir for accommodating water;
a first control circuit board;
a battery;
an electric heating module for heating water in the water reservoir; and
a water pump in fluid communication with the water reservoir;
a rotatable part, serving as a top shell of the main body, rotatable relative to the main body between a stored position and an operating position; wherein a hollow shaft is provided at a first side of the rotatable part and is rotatably connected to the main body, and a circular receptacle is provided at a second side of the rotatable part and is arranged side by side with the hollow shaft; and
an extraction head, which is placed in the water reservoir when the coffee machine is in a stored state corresponding the stored position, and is detachably connected to the circular receptacle of the rotatable part when the coffee machine is in an operating state for making coffee corresponding to the operating position of the rotatable part;
wherein, the first control circuit board is electrically connected to the battery, the electric heating module and the water pump, and all of which are arranged within a housing of the main body; in the stored state of the coffee machine, the rotatable part rests on a top wall of the main body with the circular receptacle located above the water reservoir; in the operating state, the second side of the rotatable part rotates away from the main body, the circular receptacle departs from the main body, exposing the water reservoir; and the water pump is in fluid communication with the water reservoir and the extraction head connected to the circular receptacle, delivering water from the water reservoir to the extraction head for making coffee.

2. The coffee machine as claimed in claim 1, wherein the first control circuit board has a power bank discharge function module for charging an electronic device, thereby, the coffee machine is switchable between a coffee-making function and a power bank discharge function for powering the electronic device.

3. The coffee machine as claimed in claim 2, wherein a capacity of the battery is above 20000 mAh.

4. The coffee machine as claimed in claim 2, wherein the first control circuit board is provided with a plurality of electric interfaces, a plurality of indicator lights, and a key module; the indicator lights are used for indicating a battery level or indicating time during a coffee making process;
the electric interfaces include a charging interface and a discharging interface, and the first control circuit board controls the battery to charge the electronic device through the discharging interface, thereby implementing the power bank discharge function of the coffee machine;
the housing of the main body defines an opening, the first control circuit board is disposed behind the opening, and the plurality of electric interfaces, the plurality of indicator lights and the key module extend from the first control circuit board toward the opening and are exposed on the main body for easy operation or display.

5. The coffee machine as claimed in claim 2, wherein a second control circuit board is provided within the rotatable part and is connected to the first control circuit board to implement the coffee-making function of the coffee machine; the second control circuit board is provided with an in-position switch for triggering the coffee-making function and/or the power bank discharge function.

6. The coffee machine as claimed in claim 5, wherein the second control circuit board is provided with a temperature adjustment function module and/or a time adjustment function module; adjustment keys are disposed on a housing of the rotatable part, electrically connected to the second control circuit board, and are used to set temperature and/or time during a coffee making process.

7. The coffee machine as claimed in claim 5, wherein a guide post is provided below the in-position switch and is connected to a compressible spring; the guide post is movable up and down to push or release the in-position switch.

8. The coffee machine as claimed in claim 7, wherein the top wall of the main body defines a shaft hole and a water reservoir mounting hole side by side; the hollow shaft rotatably extends within the housing of the main body through the shaft hole; the water reservoir is installed within the housing of the main body with an open top of the water reservoir received in the water reservoir mounting hole.

9. The coffee machine as claimed in claim 8, wherein the guide post is installed in the rotatable part and is rotatable along with the rotatable part; a protrusion is provided on the top wall of the main body; in the operating state, the guide post rotates onto the protrusion, the protrusion pushes the guide post to move upward to press the in-position switch, thereby triggering the coffee-making function and/or the power bank discharge function; and in the stored state, the guide post rotates away from the protrusion, and the spring drives the guide post to move downward to release the in-position switch.

10. The coffee machine as claimed in claim 9, wherein a hollow column is set through a bottom wall of the rotatable part; the guide post and the spring sleeved on the guide post are inserted in the hollow column and movable up and down along the hollow column; and the in-position switch is set on a bottom surface of the second control circuit board opposite to the hollow column.

11. The coffee machine as claimed in claim 9, wherein an annular groove around the hollow shaft is formed on a bottom wall of the rotatable part, an annular flange around the shaft hole on the top wall of the main body is slidable along the annular groove when the rotatable part rotates; an arc-shaped groove on the outer periphery of the hollow shaft is formed on the bottom wall of the rotatable part; the protrusion is in slidable engagement in the arc-shaped groove when the rotatable part rotates;
ball bearings are provided on an outer periphery of the hollow shaft, forming a rolling fit between the bottom wall of the rotatable part and the top wall of the main body; multiple bearing depressions distributed circumferentially around the shaft hole are formed on the top wall of the main body; the ball bearings are in rolling fit with the bearing depressions when the rotatable part rotates;
the protrusion is an arc corresponding to an outer periphery of the shaft hole and is located between the annular flange and a circle of the bearing depressions.

12. The coffee machine as claimed in claim 1, wherein a lower end of the hollow shaft is connected to an end cap for limiting an axial movement of the hollow shaft, allowing the hollow shaft to rotatably fit within the shaft hole without falling out.

13. The coffee machine as claimed in claim 11, wherein the end cap includes a circular upper plate and a circular lower plate fixedly connected to each other; the circular upper plate is inserted into the hollow shaft and tightly fits; the circular lower plate includes an annular sidewall so as to form an annular groove between the circular lower plate and the circular upper plate; the lower end of the hollow shaft fits into the annular groove; the circular lower plate is clamped outside the shaft hole to limit the shaft;
the shaft hole extends downward to form an annular sleeve within the main body; the hollow shaft is inserted in the annular sleeve, and the circular lower plate is clamped outside an open lower end of the annular sleeve;
an annular wall extends into the housing of the main body from the water reservoir mounting hole and is adapted to accommodate the water reservoir;
a through-hole is formed in the end cap, the circular receptacle defines a through-hole in fluid communication with the extraction head connected to the circular receptacle; a water pipe connects between the water pump and the circular receptacle through the through-hole in the end cap and the hollow shaft, one end of the water pipe is connected to a water outlet pipe of the water pump via a pipe coupling, and the other end of the water pipe is connected to the circular receptacle via another pipe coupling installed in the through-hole in the circular receptacle;
the pipe couplings are rotatable 360 degrees.

14. The coffee machine as claimed in claim 13, wherein the pipe coupling installed in the through-hole in the circular receptacle is connected to a hollow needle, the hollow needle is used for injecting water into the extraction head and piercing a coffee capsule placed in the extraction head.

15. The coffee machine as claimed in claim 1, wherein the electric heating module includes an electric heating plate serving as a bottom wall of the water reservoir;
a temperature sensor is provided for detecting water temperature in the water reservoir and is connected to the first control circuit board for controlling a heating power supplied to the electric heating module;
a heating power of the electric heating module, and a capacity and a discharge rate of the battery are configured so that the electric heating module is capable of heating the water in the water reservoir to 86-95° C. within a few minutes.

16. The coffee machine as claimed in claim 1, wherein a fan is installed within the main body, the housing of the main body defines air inlets and air outlets; a partition plate is provided between the air inlets and the air outlets, correspondingly separating a space within the housing into an air intake side and an air discharge side, and forming a U-shaped airflow path within the housing extending from the air inlets at the air intake side to the air outlets at the air discharge side; the fan is located behind the air inlets; the battery and the first control circuit board are both located within a heat-dissipation coverage of the U-shaped airflow path;
when the fan is activated, ambient air is sucked in the main body from the air inlets, flows along the U-shaped airflow path for heat exchange, and then is discharged out of the main body from the air outlets.

17. The coffee machine as claimed in claim 16, wherein a bracket is provided within the housing of the main body; the battery, the water pump, the first control circuit board, and the water reservoir are installed within the main body via the bracket; the bracket includes a top plate; an annular mounting receptacle is provided on the top plate and is adapted to the water reservoir, the bottom wall of the water reservoir is assembled in the annular mounting receptacle, and the water pump is located below the water reservoir.

18. The coffee machine as claimed in claim 17, wherein the bottom wall of the water reservoir defines a through-hole for connecting a water inlet pipe of the water pump; the bottom wall of the water reservoir defines another through-hole for installing a temperature sensor for detecting the water temperature in the water reservoir.

19. The coffee machine as claimed in claim 16, wherein the air inlets and the air outlets are defined in a bottom wall of the main body, the partition plate is set on the bottom wall of the main body and extends upward, and the first control circuit board is supported on a top of the partition plate.
